(19) United States
(12) Patent Application Publication
(10) Pub. No.: US 2006/0132813 A1
(43) Pub. Date: Jun. 22, 2006

(54) Program and displaying method for printer driver

(75) Inventors: Masateru Mitani, Shizuoka-ken (JP); Shinji Ohira, Mishima-shi (JP); Takeaki Kato, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/015,496

(22) Filed: Dec. 16, 2004

(51) Int. Cl. G06F 3/12

(52) U.S. Cl. 358/1.13

(57) ABSTRACT

In a printer driver of the invention, a setting confirmation screen of “Graphical Preview” and a setting confirmation screen of “Text Preview” can easily be switched by clicking a Graphics key or a Text key, which are provided at a lower part of the screen. Only by clicking a setting item to be changed on the setting confirmation screen, can a jump be executed to a location for actual setting. In addition, a common Graphical Preview is displayed at the same location in all tabs. A menu of the printer driver is displayed such that menu items are arranged from upper left to lower right in an order according to a frequency of use and a frequency of change of settings.

### BACKGROUND OF THE INVENTION

1. Field of the Invention

The present invention relates to a program for a printer driver and a displaying method for the printer driver in a printing system in which a personal computer and a printer are connected.

2. Description of the Related Art

In the prior art, a printer driver GUI contains about 100 items of operation settings, such as selection of a paper size and setting of a print job. All setting items cannot be displayed on a single screen. Thus, setting items are grouped on the basis of a preset standard, and the setting items that belong to the respective groups are displayed on different screens (tabs). In this method, the user is required to change the screen (tab) in accordance with settings that are to be executed, and he/she cannot view all setting items at a time. To avoid this problem, a “setting confirmation screen” is provided to display all settings that have been executed on the respective screens (tabs).

This “setting confirmation screen”, however, permits only confirmation of the settings. If the settings need to be changed after confirmation, the user is required to change the screen to a desired screen (tab) on which actual setting is to be executed.

There is known a prior-art printer driver in which a print setting screen includes a tab that is provided with a preview image for displaying a print setting status. However, there is a case where a common preview image is not used. Consequently, whenever the user confirms a preview on the print setting screen of the printer driver, he/she is required to open a tab that displays the preview.

### BRIEF SUMMARY OF THE INVENTION

The object of an aspect of the present invention is to provide a program and a displaying method for a printer driver with enhanced operability of a printer driver GUI.

According to an aspect of the present invention, there is provided a program for a printer driver that operates a printing apparatus in a system in which a personal computer and the printing apparatus are connected, the program comprising: displaying, when the printing apparatus is operated, one of a Graphical Preview and a Text Preview as a setting confirmation screen with which various settings that are input are confirmed.

According to another aspect of the present invention, there is provided a displaying method for a printer driver that operates a printing apparatus in a system in which a personal computer and the printing apparatus are connected, the method comprising: displaying, when the printing apparatus is operated, one of a Graphical Preview and a Text Preview as a setting confirmation screen with which various settings that are input are confirmed.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a printing system according to the present invention;

FIG. 2 shows an example of display in which a setup tab screen is displayed on a display unit;

FIG. 3 shows an example of display in which the setup tab screen is displayed on the display unit;

FIG. 4 is a flow chart that illustrates an operation for jumping to a designated link destination from a setting confirmation screen of “Graphical Preview” or “Text Preview”;

FIG. 5 shows an example of display in which a layout tab screen is displayed on the display unit;

FIG. 6 shows an example of display in which the setup tab screen is displayed on the display unit;

FIG. 7 shows an example of display in which the setup tab screen is displayed on the display unit; and

FIG. 8 shows an example of display in which the layout tab screen is displayed on the display unit.

### DETAILED DESCRIPTION OF THE INVENTION

An embodiment of the present invention will now be described with reference to the accompanying drawings.

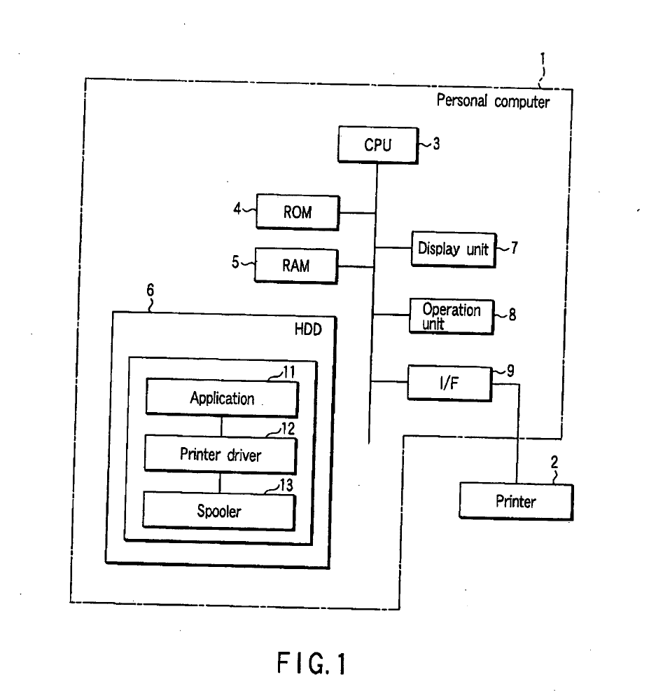

FIG. 1 schematically shows the structure of a printing system according to the present invention.

The printing system is configured such that a personal computer 1 and a printer 2 are directly connected via a USB, a parallel cable, etc. or connected via a network such as an Ethernet.

The personal computer 1 comprises a CPU 3 that executes an overall control, a ROM 4 that stores a control program, etc., a RAM 5 for data storage, a hard disk drive (HDD) 6, a display unit 7, an operation unit 8, and an interface (I/F) 9 that is connected to the printer 2.

The HDD 6 stores an application 11, a printer driver 12 and a spooler 13.

Next, a description is given of the operation of the printer driver 12 of the embodiment by the CPU 3 in the above-described structure.

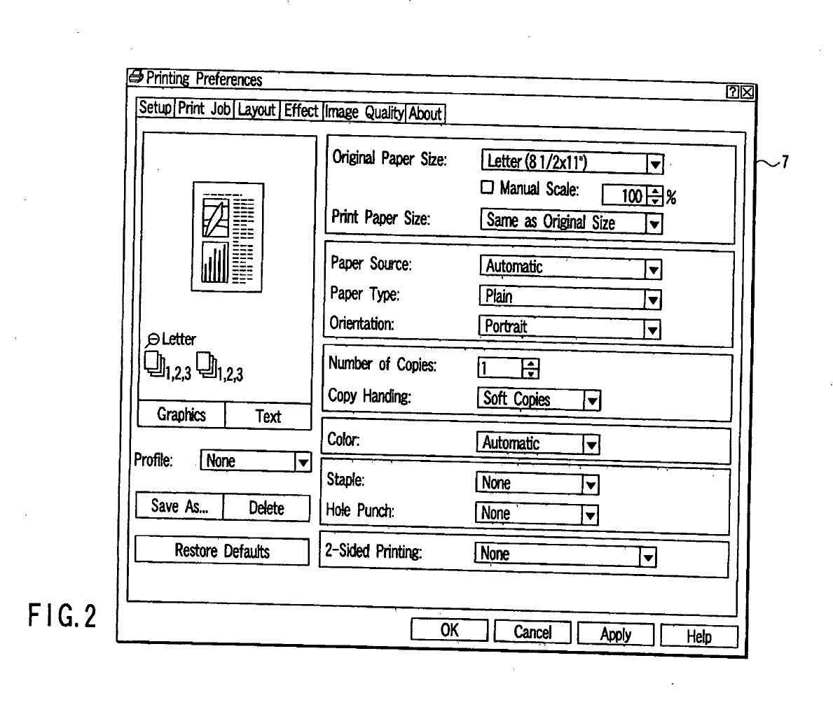

FIG. 2 shows an example of display in which a setup tab screen is displayed on the display unit 7. This example relates to a setting confirmation screen of “Graphical Preview” that enables a user to intuitively confirm settings with graphics.

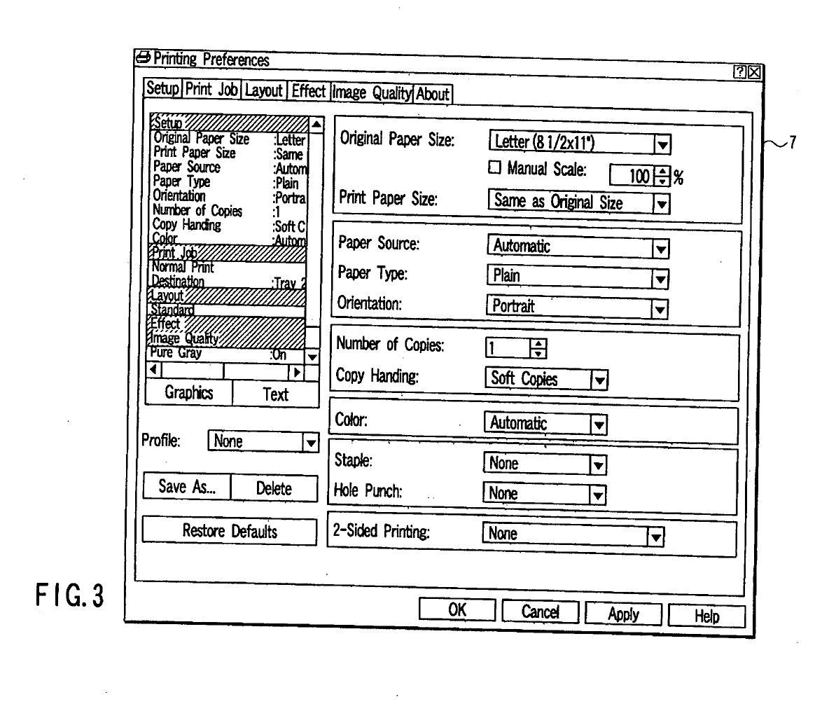

FIG. 3 shows an example of display in which the setup tab screen is displayed on the display unit 7. This example relates to a setting confirmation screen of “Text Preview” that enables a user to confirm settings with text in detail.

The setting confirmation screen of “Graphical Preview” shown in FIG. 2 and the setting confirmation screen of “Text Preview” shown in FIG. 3 can easily be switched by clicking a Graphics key or a Text key, which are provided at a lower part of the screen.

In short, according to the printer driver 12 of the present embodiment, the content of settings can be confirmed in greater detail with text, in stead of the Graphical Preview screen.

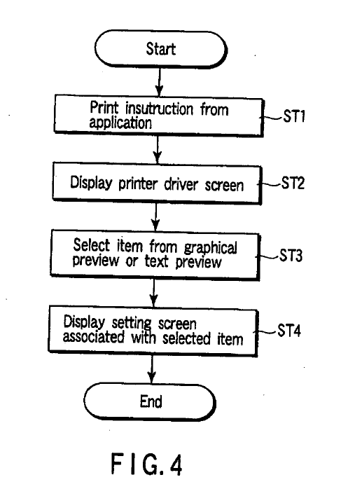

Next, referring to a flow chart of FIG. 4, a description is given of the operation for jumping to a designated link destination from the setting confirmation screen of “Graphical Preview” or “Text Preview”.

If a print instruction is issued from the application (ST1), the printer driver 12 causes the display unit 7 to display a printer driver screen (ST2).

If a setting item is selected on the setting confirmation screen of “Graphical Preview” or “Text Preview” (ST3), the printer driver 12 causes the display unit 7 to display a setting screen relating to the selected setting item (ST4).

Consider the case where the paper size is to be changed.

On the setting confirmation screen of “Graphical Preview” shown in FIG. 2, if “Letter” within “Graphical Preview” is clicked (ST3), a jump is executed to “paper size” settings (ST4).

On the setting confirmation screen of “Text Preview” shown in FIG. 3, if “Original Paper Size: Letter” within “Text Preview” is clicked (ST3), a jump is executed to “paper size” settings (ST4).

As has been described above, according to the printer driver 12 of the present embodiment, the setting items displayed on the “setting confirmation screen” are linked to locations for executing actual setting. Only by clicking a setting item to be changed on the 'setting confirmation screen”, can a jump be executed to the location for actual setting. Thereby, compared to the prior art, a more intuitive operation is possible and the operability is enhanced.

Next, a description is given of common display on the Graphical Preview screen between the respective tabs.

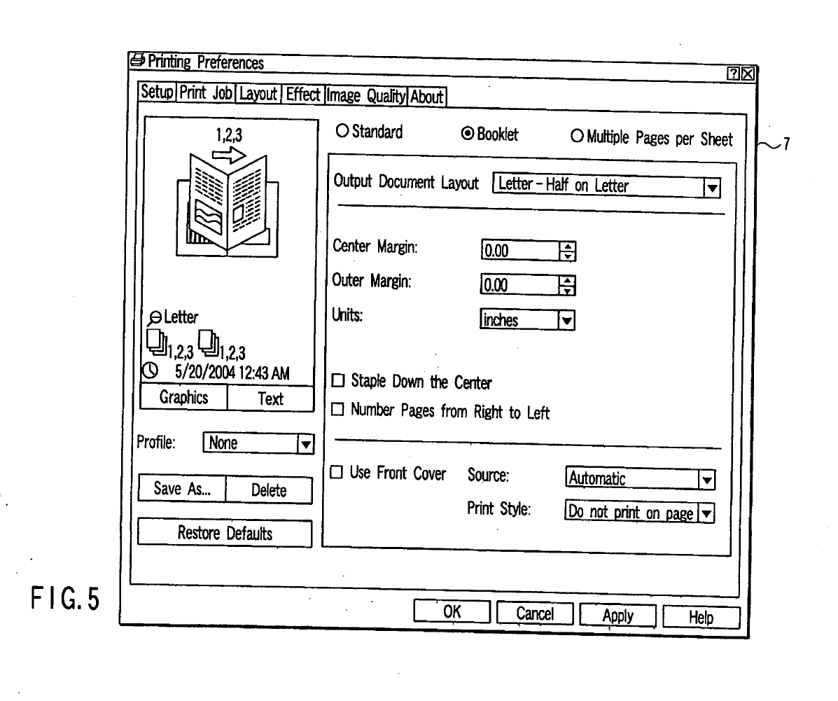

FIG. 5 shows an example of display in which the layout tab screen is displayed on the display unit 7.

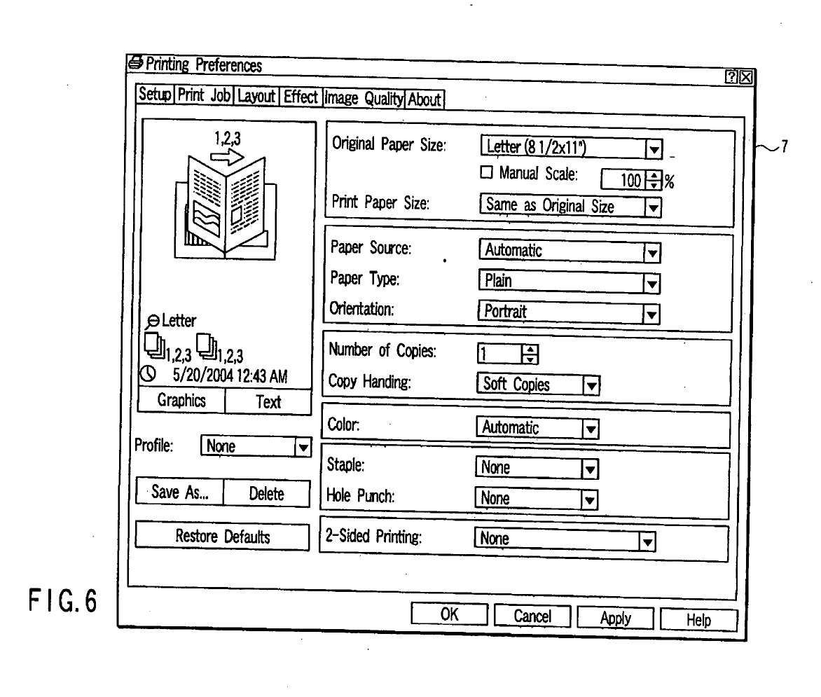

FIG. 6 shows an example of display in which the setup tab screen is displayed on the display unit 7.

As is shown in FIG. 5 and FIG. 6, the setting confirmation screen of “Graphical Preview” is common between the different tab screens. In other words, during the print setting of the printer driver 12, the user can view the Graphical Preview, which displays the current status of print settings, in any of the tabs. Moreover, the common Graphical Preview is displayed at the same location in all tabs. In this way, in the printer driver 12 of the present embodiment, the common Graphical Preview can be displayed at the same location in all tabs.

Similarly, on the setting confirmation screen of the Text Preview, the common Text Preview is displayed at the same location even if the tab screen is changed.

Thereby, the user can confirm the Graphical Preview or Text Preview in any of the tabs of the printer driver 12.

Next, a description is given of the arrangement of display on the display unit 7 on the menu of the printer driver 12.

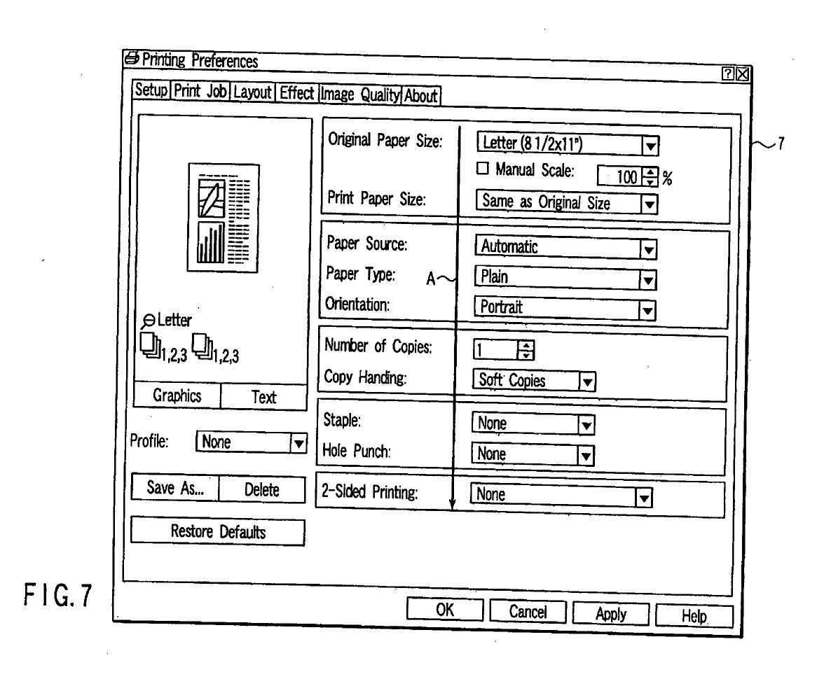

FIG. 7 shows an example of display in which the setup tab screen is displayed on the display unit 7.

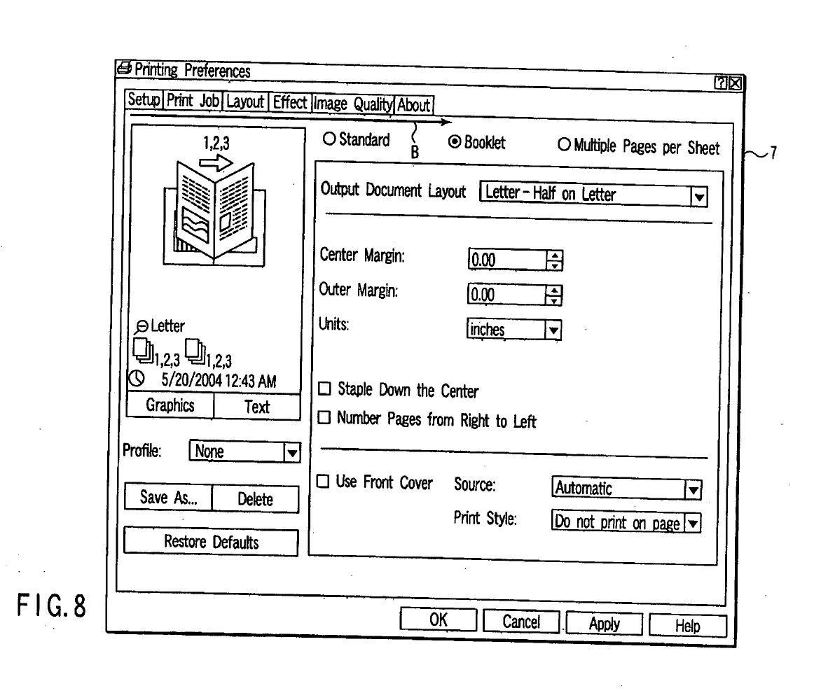

FIG. 8 shows an example of display in which the layout tab screen is displayed on the. display unit 7.

As is indicated by arrow A in FIG. 7 and arrow B in FIG. 8, the setting items on the menu of the printer driver 12 are arranged from the upper left (upper side) to the lower right (lower side) in accordance with the frequency of use and the frequency of change of settings. As regards the menu tabs, too, these tabs are arranged from the left to the right in accordance with the frequency of use and the frequency of change of settings.

What are required for the user interface (UI) are the usability and the ease in understanding. According to the printer driver 12 of the present embodiment, these requirements are satisfied in association with the flow of printing.

In the settings of print, there are a more frequently used item and a less frequently used item. For example, when the setting for the number of copies and the setting for the toner save are compared, the frequency of the former is obviously higher.

In the printer driver 12 of the present embodiment, the setting items are arranged in accordance with the frequency of use by the user. Thereby, the user can execute settings with a smooth flow, and the time from input to output can be shortened.

In addition, by arranging the setting items in consideration of functions, the setting error is prevented.

Specifically, the setting items that are associated with functions are gathered and arranged in the same tab. In the tab, the setting items are arranged from the upper side to the lower side in accordance with the frequency of use, as shown in FIG. 7. As regards the menu tabs, too, the tabs are arranged from the left to the right in accordance with the frequency of use, as shown in FIG. B.

For example, in the setup tab shown in FIG. 7, the basic print setting items are arranged. Of the setting items relating to actually output print matters, the items are arranged in the order of “size”, “type”, “orientation”, “number of copies” and “color” relating to paper. With this arrangement, the easy-to-understand user interface (UI) is realized, and the print setting items are arranged from the upper side and lower side and the setting flow is executed in this order. Hence, the user interface (UI) with high usability is realized.

As has been described above, the embodiment of the invention can provide a program for a printer driver and a displaying method for the printer driver with enhanced operability of a printer driver GUI.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A program for a printer driver that operates a printing apparatus in a system in which a personal computer and the printing apparatus are connected, the program comprising:
displaying, when the printing apparatus is operated, one of a Graphical Preview and a Text Preview as a setting confirmation screen with which various settings that are input are confirmed.

2. The program for a printer driver, according to claim 1, wherein the program displays a Graphics key and a Text key along with the setting confirmation screen, displays the Graphical Preview in accordance with clicking of the Graphics key, and displays the Text Preview in accordance with clicking of the Text key.

3. The program for a printer driver, according to claim 1, wherein the program displays, when a portion indicative of a setting content in the Graphical Preview that serves as the setting confirmation screen is clicked, a setting screen that enables a change of the setting content.

4. The program for a printer driver, according to claim 1, wherein the program displays, when a setting item in the Text Preview that serves as the setting confirmation screen is clicked, a setting screen that enables a change of the setting item.

5. The program for a printer driver, according to claim 1, wherein the program displays, when a tab on a menu of a plurality of tabs is selected, a tab screen that is associated with the selected tab, and displays the Graphical Preview or the Text Preview, which displays a current setting status, at the same location no matter which tab screen is displayed.

6. The program for a printer driver, according to claim 1, wherein the program displays, when a tab menu for selecting one of a plurality of tabs is to be displayed, the tab menu such that tabs are arranged from left to right in an order according to a frequency of use and a frequency of change of settings.

7. The program for a printer driver, according to claim 1, wherein the program includes a plurality of tab screens and displays each of the tab screens such that setting items are arranged from upper left to lower right in an order according to a frequency of use and a frequency of change of settings.

8. The program for a printer driver, according to claim 1, wherein the program includes a plurality of tab screens, in each of which setting items with associated functions are gathered and arranged, each of the tab screens displaying the setting items such that the setting items are arranged from upper left to lower right in an order according to a frequency of use and a frequency of change of settings.

9. A displaying method for a printer driver that operates a printing apparatus in a system in which a personal computer and the printing apparatus are connected, the method comprising:
displaying, when the printing apparatus is operated, one of a Graphical Preview and a Text Preview as a setting confirmation screen with which various settings that are input are confirmed.

10. The displaying method for a printer driver, according to claim 9, wherein the method comprises displaying a Graphics key and a Text key along with the setting confirmation screen, displaying the Graphical Preview in accordance with clicking of the Graphics key, and displaying the Text Preview in accordance with clicking of the Text key.

11. The displaying method for a printer driver, according to claim 9, wherein the method comprises displaying, when a portion indicative of a setting content in the Graphical Preview that serves as the setting confirmation screen is clicked, a setting screen that enables a change of the setting content.

12. The displaying method for a printer driver, according to claim 9, wherein the method comprises displaying, when a setting item in the Text Preview that serves as the setting confirmation screen is clicked, a setting screen that enables a change of the setting item.

13. The displaying method for a printer driver, according to claim 9, wherein the method comprises displaying, when a tab on a menu of a plurality of tabs is selected, a tab screen that is associated with the selected tab, and displaying the Graphical Preview or the Text Preview, which displays a current setting status, at the same location no matter which tab screen is displayed.

14. The displaying method for a printer driver, according to claim 9, wherein the method comprises displaying, when a tab menu for selecting one of a plurality of tabs is to be displayed, the tab menu such that tabs are arranged from left to right in an order according to a frequency of use and a frequency of change of settings.

15. The displaying method for a printer driver, according to claim 9, wherein the method comprises providing a plurality of tab screens and displaying each of the tab screens such that setting items are arranged from upper left to lower right in an order according to a frequency of use and a frequency of change of settings.

16. The displaying method for a printer driver, according to claim 9, wherein the method comprises providing a plurality of tab screens, in each of which setting items with associated functions are gathered and arranged, each of the tab screens displaying the setting items such that the setting items are arranged from upper left to lower right in an order according to a frequency of use and a frequency of change of settings.
